(19) United States
(12) Patent Application Publication
(10) Pub. No.: US 2023/0214703 A1
(43) Pub. Date: Jul. 6, 2023

(54) PREDICTING ENERGY PRODUCTION FOR ENERGY GENERATING ASSETS

(71) Applicant: SPARKCOGNITION, INC., Austin, TX (US)

(72) Inventors: SAHIL MAHESWARI, BELMONT, CA (US); SANDEEP GUPTA, MENLO PARK, CA (US); JAYESH SHAH, SANTA CLARA, CA (US)

(21) Appl. No.: 17/566,246

(22) Filed: Dec. 30, 2021

(51) Int. Cl. G06N 20/00; G06Q 30/02; G01W 1/10

(52) U.S. Cl. CPC G06N 20/00; G06Q 30/0283; G01W 1/10

(57) ABSTRACT

Predicting energy production for energy generating assets, including: receiving current and forecasted meteorological data associated with a location of an energy generating asset; and predicting an energy production value produced by the energy generating asset at a predetermined time based on the current and forecasted meteorological data using a trained model for the energy generating asset, the trained model being trained using a machine learning algorithm that utilizes historical meteorological data associated with the location of the energy generating asset and historical production capability data associated with a historical production capability of the energy generating asset.

### BACKGROUND

Many devices require electrical energy to operate. As the number of energy consuming devices has increased, demand for electrical energy has also increased. With the increase in demand for electrical energy, new sources of electrical energy have emerged. Of particular interest are sources of renewable energy such as, for example, wind turbines, solar panels, inverters and so on. The amount of energy that will be produced by such renewable sources of energy, however, is often a function of environmental factors that are out of the control of the owners, operators, and consumers of renewable energy. As such, predicting how much energy will be produced by such energy generating assets can be very challenging.

### BRIEF DESCRIPTION OF THE DRAWINGS

FIG. 1 sets forth a block diagram of automated computing machinery comprising an example computing system configured for predicting energy production for energy generating assets according to some embodiments of the present disclosure.

FIG. 2 sets forth a flowchart illustrating an example method of predicting energy production for energy generating assets in accordance with some embodiments of the present disclosure.

FIG. 3 sets forth a flowchart illustrating an additional example method of predicting energy production for energy generating assets in accordance with some embodiments of the present disclosure.

### DETAILED DESCRIPTION

Systems, methods, and products are described for predicting energy production for energy generating assets. According to a particular aspect, machine-learning models (e.g., neural networks) may be used to account for dynamic relationships among measurable values representing operation of a monitored system. The monitored system may be embodied as a collection of mechanical components, electrical components, and other components that collectively operate as an energy generator (i.e., a renewable energy generating asset). The monitored system may be embodied as, for example, one or more wind turbines, one or more solar panels, or some other energy generating asset.

The machine-learning models may be trained to establish a relationship between two or more measurable data values. The measurable data values may include, for example, a first data value that represents a wind speed measured by an anemometer that is mounted on a wind turbine and a second data value that represents the amount of energy generated by the wind turbine. The measurable data values may form a time series that includes multiple time windowed portions where each time windowed portion includes multivariate data (e.g., data from multiple sensors). In some implementations, the machine-learning model may be used to predict future values of the time-series data by using predicted measurable values as input. For example, given a predicted wind speed, the machine-learning model may be used to predict the amount of energy that a monitored wind turbine would generate, based on machine-learned correlations between measured wind speeds and measured energy output from the wind turbine. As such, the machine-learning model may evaluate input data to predict a future value of the time series. For example, the parameters may include link weights of a neural network, may include kernel parameters of a convolutional neural network (CNN), or may include both link weights and kernel parameters.

In some embodiments, two or more machine-learning models (e.g., neural networks) are used together to account for dynamic relationships among sensor data values representing operation of a monitored system. The sensor data values form a time series that includes multiple time windowed portions where each time windowed portion includes multivariate data (e.g., data from multiple sensors). In some implementations, a first machine-learning model evaluates input data based on multivariate sensor data from the monitored system to generate parameters for the second network. The second machine-learning model uses the parameters and input data to predict future values of the time-series data.

The parameters generated by the first machine-learning model are dependent on relationships among features of the time-series data. In some implementations, the first machine-learning model is a variational dimensional-reduction model that dimensionally reduces the input data and fits the dimensionally reduced input data to a probability distribution (e.g., a Gaussian distribution) to facilitate latent-space regularization and to facilitate separation of recognized operational states of the monitored system in the latent space. By way of illustration, in some implementations, the first machine-learning model is similar to a variational autoencoder except that, unlike an autoencoder, the first machine-learning model does not attempt to reproduce its input data. Rather, the first machine-learning model is trained to select appropriate parameters for the second machine-learning model.

The output of the first machine-learning model includes (or is mapped to) parameters that are used by the second machine-learning model to evaluate input data to predict a future value of the time series. For example, the parameters may include link weights of a neural network, may include kernel parameters of a convolutional neural network (CNN), or may include both link weights and kernel parameters.

Using two machine-learning models enables a monitoring system to perform forecasting in a manner that is state-dependent (e.g., is based on an inferred operating state of the monitored system), which may provide more accurate forecasting results when the monitored system is operating in any of several normal operating states. Additionally, in some implementations, the monitoring system can perform other operations, such as identifying the inferred operating state of the monitored system based on a dimensionally reduced encoding representing the input data. In such implementations, the inferred operating state can be used to improve situational awareness of operators associated with the monitored device. Additionally, or alternatively, the inferred operating state can be used to select a behavior model that can be used for anomaly detection (e.g., to determine whether the monitored system has deviated from the inferred operating state).

Used in this manner, the two machine-learning models may provide more accurate detection of changes in an operating state of the monitored system. Additionally, the situational awareness of operators of the monitored system can be improved, such as by providing output identifying an inferred operating state of the monitored system along with alerting information if the monitored system deviates from a particular operating state.

Particular aspects of the present disclosure are described below with reference to the drawings. In the description, common features are designated by common reference numbers throughout the drawings. As used herein, various terminology is used for the purpose of describing particular implementations only and is not intended to be limiting. For example, the singular forms “a,” “an,” and “the” are intended to include the plural forms as well, unless the context clearly indicates otherwise. Further the terms “comprise,” “comprises,” and “comprising” may be used interchangeably with “include,” “includes,” or “including.” Additionally, the term “wherein” may be used interchangeably with “where.” As used herein, “exemplary” may indicate an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

In the present disclosure, terms such as “determining,” “calculating,” “estimating,” “shifting,” “adjusting,” etc. may be used to describe how one or more operations are performed. Such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive electrical signals (digital signals or analog signals) directly or indirectly, such as via one or more wires, buses, networks, etc. As used herein, “directly coupled” may include two devices that are coupled (e.g., communicatively coupled, electrically coupled, or physically coupled) without intervening components.

As used herein, the term “machine learning” should be understood to have any of its usual and customary meanings within the fields of computers science and data science, such meanings including, for example, processes or techniques by which one or more computers can learn to perform some operation or function without being explicitly programmed to do so. As a typical example, machine learning can be used to enable one or more computers to analyze data to identify patterns in data and generate a result based on the analysis. For certain types of machine learning, the results that are generated include data that indicates an underlying structure or pattern of the data itself. Such techniques, for example, include so called “clustering” techniques, which identify clusters (e.g., groupings of data elements of the data).

For certain types of machine learning, the results that are generated include a data model (also referred to as a “machine-learning model” or simply a “model”). Typically, a model is generated using a first data set to facilitate analysis of a second data set. For example, a first portion of a large body of data may be used to generate a model that can be used to analyze the remaining portion of the large body of data. As another example, a set of historical data can be used to generate a model that can be used to analyze future data.

Since a model can be used to evaluate a set of data that is distinct from the data used to generate the model, the model can be viewed as a type of software (e.g., instructions, parameters, or both) that is automatically generated by the computer(s) during the machine-learning process. As such, the model can be portable (e.g., can be generated at a first computer, and subsequently moved to a second computer for further training, for use, or both). Additionally, a model can be used in combination with one or more other models to perform a desired analysis. To illustrate, first data can be provided as input to a first model to generate first model output data, which can be provided (alone, with the first data, or with other data) as input to a second model to generate second model output data indicating a result of a desired analysis. Depending on the analysis and data involved, different combinations of models may be used to generate such results. In some examples, multiple models may provide model output that is input to a single model. In some examples, a single model provides model output to multiple models as input.

Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, deep belief networks, etc. Variants of decision trees include, for example and without limitation, random forests, boosted decision trees, etc.

Since machine-learning models are generated by computer(s) based on input data, machine-learning models can be discussed in terms of at least two distinct time windows — a creation/training phase and a runtime phase. During the creation/training phase, a model is created, trained, adapted, validated, or otherwise configured by the computer based on the input data (which in the creation/training phase, is generally referred to as “training data”). Note that the trained model corresponds to software that has been generated and/or refined during the creation/training phase to perform particular operations, such as classification, prediction, encoding, or other data analysis or data synthesis operations. During the runtime phase (or “inference” phase), the model is used to analyze input data to generate model output. The content of the model output depends on the type of model. For example, a model can be trained to perform classification tasks or regression tasks, as non-limiting examples. In some implementations, a model may be continuously, periodically, or occasionally updated, in which case training time and runtime may be interleaved or one version of the model can be used for inference while a copy is updated, after which the updated copy may be deployed for inference.

In some implementations, a previously generated model is trained (or re-trained) using a machine-learning technique. In this context, “training” refers to adapting the model or parameters of the model to a particular data set. Unless otherwise clear from the specific context, the term “training” as used herein includes “re-training” or refining a model for a specific data set. For example, training may include so called “transfer learning.” As described further below, in transfer learning a base model may be trained using a generic or typical data set, and the base model may be subsequently refined (e.g., re-trained or further trained) using a more specific data set.

A data set used during training is referred to as a “training data set” or simply “training data”. The data set may be labeled or unlabeled. “Labeled data” refers to data that has been assigned a categorical label indicating a group or category with which the data is associated, and “unlabeled data” refers to data that is not labeled. Typically, “supervised machine-learning processes” use labeled data to train a machine-learning model, and “unsupervised machine-learning processes” use unlabeled data to train a machine-learning model; however, it should be understood that a label associated with data is itself merely another data element that can be used in any appropriate machine-learning process. To illustrate, many clustering operations can operate using unlabeled data; however, such a clustering operation can use labeled data by ignoring labels assigned to data or by treating the labels the same as other data elements.

Machine-learning models can be initialized from scratch (e.g., by a user, such as a data scientist) or using a guided process (e.g., using a template or previously built model). Initializing the model includes specifying parameters and hyperparameters of the model. “Hyperparameters” are characteristics of a model that are not modified during training, and “parameters” of the model are characteristics of the model that are modified during training. The term “hyperparameters” may also be used to refer to parameters of the training process itself, such as a learning rate of the training process. In some examples, the hyperparameters of the model are specified based on the task the model is being created for, such as the type of data the model is to use, the goal of the model (e.g., classification, regression, anomaly detection), etc. The hyperparameters may also be specified based on other design goals associated with the model, such as a memory footprint limit, where and when the model is to be used, etc.

Model type and model architecture of a model illustrate a distinction between model generation and model training. The model type of a model, the model architecture of the model, or both, can be specified by a user or can be automatically determined by a computing device. However, neither the model type nor the model architecture of a particular model is changed during training of the particular model. Thus, the model type and model architecture are hyperparameters of the model and specifying the model type and model architecture is an aspect of model generation (rather than an aspect of model training). In this context, a “model type” refers to the specific type or sub-type of the machine-learning model. As noted above, examples of machine-learning model types include, without limitation, perceptrons, neural networks, support vector machines, regression models, decision trees, Bayesian models, Boltzmann machines, adaptive neuro-fuzzy inference systems, as well as combinations, ensembles and variants of these and other types of models. In this context, “model architecture” (or simply “architecture”) refers to the number and arrangement of model components, such as nodes or layers, of a model, and which model components provide data to or receive data from other model components. As a non-limiting example, the architecture of a neural network may be specified in terms of nodes and links. To illustrate, a neural network architecture may specify the number of nodes in an input layer of the neural network, the number of hidden layers of the neural network, the number of nodes in each hidden layer, the number of nodes of an output layer, and which nodes are connected to other nodes (e.g., to provide input or receive output). As another non-limiting example, the architecture of a neural network may be specified in terms of layers. To illustrate, the neural network architecture may specify the number and arrangement of specific types of functional layers, such as long-short-term memory (LSTM) layers, fully connected (FC) layers, convolution layers, etc. While the architecture of a neural network implicitly or explicitly describes links between nodes or layers, the architecture does not specify link weights. Rather, link weights are parameters of a model (rather than hyperparameters of the model) and are modified during training of the model.

In many implementations, a data scientist selects the model type before training begins. However, in some implementations, a user may specify one or more goals (e.g., classification or regression), and automated tools may select one or more model types that are compatible with the specified goal(s). In such implementations, more than one model type may be selected, and one or more models of each selected model type can be generated and trained. A best performing model (based on specified criteria) can be selected from among the models representing the various model types. Note that in this process, no particular model type is specified in advance by the user, yet the models are trained according to their respective model types. Thus, the model type of any particular model does not change during training.

Similarly, in some implementations, the model architecture is specified in advance (e.g., by a data scientist); whereas in other implementations, a process that both generates and trains a model is used. Generating (or generating and training) the model using one or more machine-learning techniques is referred to herein as “automated model building”. In one example of automated model building, an initial set of candidate models is selected or generated, and then one or more of the candidate models are trained and evaluated. In some implementations, after one or more rounds of changing hyperparameters and/or parameters of the candidate model(s), one or more of the candidate models may be selected for deployment (e.g., for use in a runtime phase).

Certain aspects of an automated model building process may be defined in advance (e.g., based on user settings, default values, or heuristic analysis of a training data set) and other aspects of the automated model building process may be determined using a randomized process. For example, the architectures of one or more models of the initial set of models can be determined randomly within predefined limits. As another example, a termination condition may be specified by the user or based on configurations settings. The termination condition indicates when the automated model building process should stop. To illustrate, a termination condition may indicate a maximum number of iterations of the automated model building process, in which case the automated model building process stops when an iteration counter reaches a specified value. As another illustrative example, a termination condition may indicate that the automated model building process should stop when a reliability metric associated with a particular model satisfies a threshold. As yet another illustrative example, a termination condition may indicate that the automated model building process should stop if a metric that indicates improvement of one or more models over time (e.g., between iterations) satisfies a threshold. In some implementations, multiple termination conditions, such as an iteration count condition, a time limit condition, and a rate of improvement condition can be specified, and the automated model building process can stop when one or more of these conditions is satisfied.

Another example of training a previously generated model is transfer learning. “Transfer learning” refers to initializing a model for a particular data set using a model that was trained using a different data set. For example, a “general purpose” model can be trained to detect anomalies in vibration data associated with a variety of types of rotary equipment, and the general-purpose model can be used as the starting point to train a model for one or more specific types of rotary equipment, such as a first model for generators and a second model for pumps. As another example, a general-purpose natural-language processing model can be trained using a large selection of natural-language text in one or more target languages. In this example, the general-purpose natural-language processing model can be used as a starting point to train one or more models for specific natural-language processing tasks, such as translation between two languages, question answering, or classifying the subject matter of documents. Often, transfer learning can converge to a useful model more quickly than building and training the model from scratch.

Training a model based on a training data set generally involves changing parameters of the model with a goal of causing the output of the model to have particular characteristics based on data input to the model. To distinguish from model generation operations, model training may be referred to herein as optimization or optimization training. In this context, “optimization” refers to improving a metric, and does not mean finding an ideal (e.g., global maximum or global minimum) value of the metric. Examples of optimization trainers include, without limitation, backpropagation trainers, derivative free optimizers (DFOs), and extreme learning machines (ELMs). As one example of training a model, during supervised training of a neural network, an input data sample is associated with a label. When the input data sample is provided to the model, the model generates output data, which is compared to the label associated with the input data sample to generate an error value. Parameters of the model are modified in an attempt to reduce (e.g., optimize) the error value. As another example of training a model, during unsupervised training of an autoencoder, a data sample is provided as input to the autoencoder, and the autoencoder reduces the dimensionality of the data sample (which is a lossy operation) and attempts to reconstruct the data sample as output data. In this example, the output data is compared to the input data sample to generate a reconstruction loss, and parameters of the autoencoder are modified in an attempt to reduce (e.g., optimize) the reconstruction loss.

As another example, to use supervised training to train a model to perform a classification task, each data element of a training data set may be labeled to indicate a category or categories to which the data element belongs. In this example, during the creation/training phase, data elements are input to the model being trained, and the model generates output indicating categories to which the model assigns the data elements. The category labels associated with the data elements are compared to the categories assigned by the model. The computer modifies the model until the model accurately and reliably (e.g., within some specified criteria) assigns the correct labels to the data elements. In this example, the model can subsequently be used (in a runtime phase) to receive unknown (e.g., unlabeled) data elements, and assign labels to the unknown data elements. In an unsupervised training scenario, the labels may be omitted. During the creation/training phase, model parameters may be tuned by the training algorithm in use such that the during the runtime phase, the model is configured to determine which of multiple unlabeled “clusters” an input data sample is most likely to belong to.

As another example, to train a model to perform a regression task, during the creation/training phase, one or more data elements of the training data are input to the model being trained, and the model generates output indicating a predicted value of one or more other data elements of the training data. The predicted values of the training data are compared to corresponding actual values of the training data, and the computer modifies the model until the model accurately and reliably (e.g., within some specified criteria) predicts values of the training data. In this example, the model can subsequently be used (in a runtime phase) to receive data elements and predict values that have not been received. To illustrate, the model can analyze time-series data, in which case, the model can predict one or more future values of the time series based on one or more prior values of the time series.

In some aspects, the output of a model can be subjected to further analysis operations to generate a desired result. To illustrate, in response to particular input data, a classification model (e.g., a model trained to perform classification tasks) may generate output including an array of classification scores, such as one score per classification category that the model is trained to assign. Each score is indicative of a likelihood (based on the model's analysis) that the particular input data should be assigned to the respective category. In this illustrative example, the output of the model may be subjected to a softmax operation to convert the output to a probability distribution indicating, for each category label, a probability that the input data should be assigned the corresponding label. In some implementations, the probability distribution may be further processed to generate a one-hot encoded array. In other examples, other operations that retain one or more category labels and a likelihood value associated with each of the one or more category labels can be used.

One example of a machine-learning model is an autoencoder. An autoencoder is a particular type of neural network that is trained to receive multivariate input data, to process at least a subset of the multivariate input data via one or more hidden layers, and to perform operations to reconstruct the multivariate input data using output of the hidden layers. If at least one hidden layer of an autoencoder includes fewer nodes than the input layer of the autoencoder, the autoencoder may be considered a type of dimensional-reduction model. If each of the one or more hidden layer(s) of the autoencoder includes more nodes than the input layer of the autoencoder, the autoencoder may be referred to herein as a denoising model or a sparse model, as explained further below.

For dimensional reduction type autoencoders, the hidden layer with the fewest nodes is referred to as the latent-space layer. Thus, a dimensional reduction autoencoder is trained to receive multivariate input data, to perform operations to dimensionally reduce the multivariate input data to generate latent-space data in the latent-space layer, and to perform operations to reconstruct the multivariate input data using the latent-space data.

As used herein, “dimensional reduction” refers to representing n values of multivariate input data using z values (e.g., as latent-space data), where n and z are integers and z is less than n. Often, in an autoencoder the z values of the latent-space data are then dimensionally expanded to generate n values of output data. In some special cases, a dimensional-reduction model may generate m values of output data, where m is an integer that is not equal to n. As used herein, such special cases are still referred to as autoencoders as long as the data values represented by the input data are a subset of the data values represented by the output data or the data values represented by the output data are a subset of the data values represented by the input data. For example, if the multivariate input data includes 10 sensor data values from 10 sensors, and the dimensional-reduction model is trained to generate output data representing only 5 sensor data values corresponding to 5 of the 10 sensors, then the dimensional-reduction model is referred to herein as an autoencoder. As another example, if the multivariate input data includes 10 sensor data values from 10 sensors, and the dimensional-reduction model is trained to generate output data representing 10 sensor data values corresponding to the 10 sensors and to generate a variance value (or other statistical metric) for each of the sensor data values, then the dimensional-reduction model is also referred to herein as an autoencoder (e.g., a variational autoencoder). If a model performs dimensional reduction but does not attempt to recreate the input data, the model is referred to herein merely as a dimensional-reduction model.

Denoising autoencoders and sparse autoencoders do not include a latent-space layer to force changes in the input data. An autoencoder without a latent-space layer could simply pass the input data, unchanged, to the output nodes resulting in a model with little utility. Denoising autoencoders avoid this result by zeroing out a subset of values of an input data set while training the denoising autoencoder to reproduce the entire input data set at the output nodes. Put another way, the denoising autoencoder is trained to reproduce an entire input data sample based on input data that includes less than the entire input data sample. For example, during training of a denoising autoencoder that includes 10 nodes in the input layer and 10 nodes in the output layer, a single set of input data values includes 10 data values; however, only a subset of the 10 data values (e.g., between 2 and 9 data values) are provided to the input layer. The remaining data values are zeroed out. To illustrate, out of 10 data values, 7 data values may be provided to a respective 7 nodes of the input layer, and zero values may be provided to the other 3 nodes of the input layer. Fitness of the denoising autoencoder is evaluated based on how well the output layer reproduces all 10 data values of the set of input data values, and during training, parameters of the denoising autoencoder are modified over multiple iterations to improve its fitness.

Sparse autoencoders prevent passing the input data unchanged to the output nodes by selectively activating a subset of nodes of one or more of the hidden layers of the sparse autoencoder. For example, if a particular hidden layer has 10 nodes, only 3 nodes may be activated for particular data. The sparse autoencoder is trained such that which nodes are activated is data dependent. For example, for a first data sample, 3 nodes of the particular hidden layer may be activated, whereas for a second data sample, 5 nodes of the particular hidden layer may be activated.

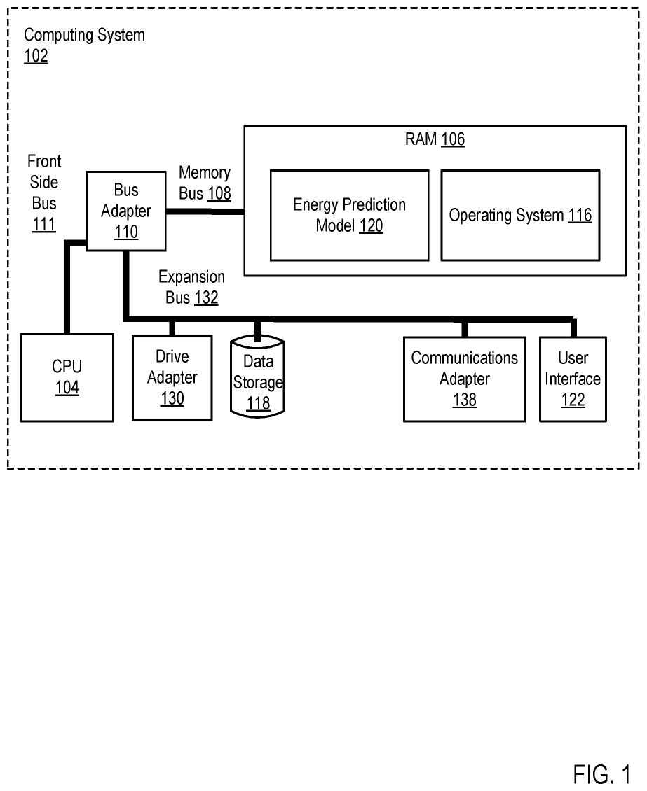

Predicting energy production for energy generating assets in accordance with the present disclosure is generally implemented with computers, that is, with automated computing machinery. For further explanation, therefore, FIG. 1 sets forth a block diagram of automated computing machinery comprising an example computing system 102 configured for predicting energy production for energy generating assets according to some embodiments of the present disclosure. The computing system 102 of FIG. 1 includes a Central Processing Unit (CPU') 104 as well as random access memory (RAM') 106 which is connected through a high speed memory bus 108 and bus adapter 110 to the CPU 104 via a front side bus 111 and to other components of the computing system 102. Although a CPU 104 is illustrated in the example depicted in FIG. 1, in other embodiments other forms of processing devices may be utilized such as, for example, an application-specific integrated circuit (‘ASIC’), field-programmable gate array (‘FPGA’), and so on.

Stored in RAM 106 is an energy prediction model 120. The energy prediction model 120 may be embodied as a module of computer program instructions that, when executed, cause the computing system to carry out (among other steps) the steps of: receiving current meteorological data associated with a location of an energy generating asset and predicting an energy production value produced by the energy generating asset at a predetermined time based on the current meteorological data. The energy prediction model 120 may be embodied as a trained model that was trained using a machine learning algorithm that utilizes historical meteorological data associated with the location of the energy generating asset and historical production capability data associated with a historical production capability of the energy generating asset.

Further stored in RAM 106 is an operating system 116. Operating systems 116 useful in vehicles in accordance with some embodiments of the present disclosure include UNIX™, Linux™, Microsoft Windows™, AIX™, IBM's i OS™, and others as will occur to those of skill in the art. The energy prediction model 120 and the operating system 116 in the example of FIG. 1 are shown in RAM 106, but many components of such software may alternatively be stored in non-volatile memory also, such as, for example, on data storage 118, such as a disk drive. Moreover, any of the energy prediction model 120 may be executed in a virtual machine and facilitated by a guest operating system of that virtual machine.

The computing system 102 of FIG. 1 includes disk drive adapter 130 coupled through expansion bus 132 and bus adapter 110 to CPU 104 and other components of the computing system 102. Disk drive adapter 130 connects non-volatile data storage to the computing system 102 in the form of data storage 118 (which may in alternative embodiments be accessible directly via the expansion bus 132 without going through the disk drive adapter). Disk drive adapters 130 useful in computers configured for contactless payment from a vehicle according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The computing system 102 of FIG. 1 also includes a communications adapter 138 for data communications with other computers and for data communications with a data communications network. Such data communications may be carried out serially through RS-138 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful in computers configured for contactless payment from a vehicle according to embodiments of the present invention include modems for wired dial-up communications, Ethernet (IEEE 802.3) adapters for wired data communications, 802.11 adapters for wireless data communications, as well as mobile adapters (e.g., cellular communications adapters) for mobile data communications.

Readers will appreciate that although the example embodiment depicted in FIG. 1 relates to an embodiment where an energy prediction model 120 is executed in a computing system 102, in other embodiments the energy prediction model 120 may be executed elsewhere. For example, the energy prediction model 120 may be executed in one or more cloud computing environments such as, for example, Amazon AWS, Google Cloud Platform, Microsoft Azure, and so on. In such an example, the energy prediction model 120 may be executed on one or more cloud computing instances (e.g., one or more EC2 instances), on one or more virtual machines, in one or more containers, or in some other way.

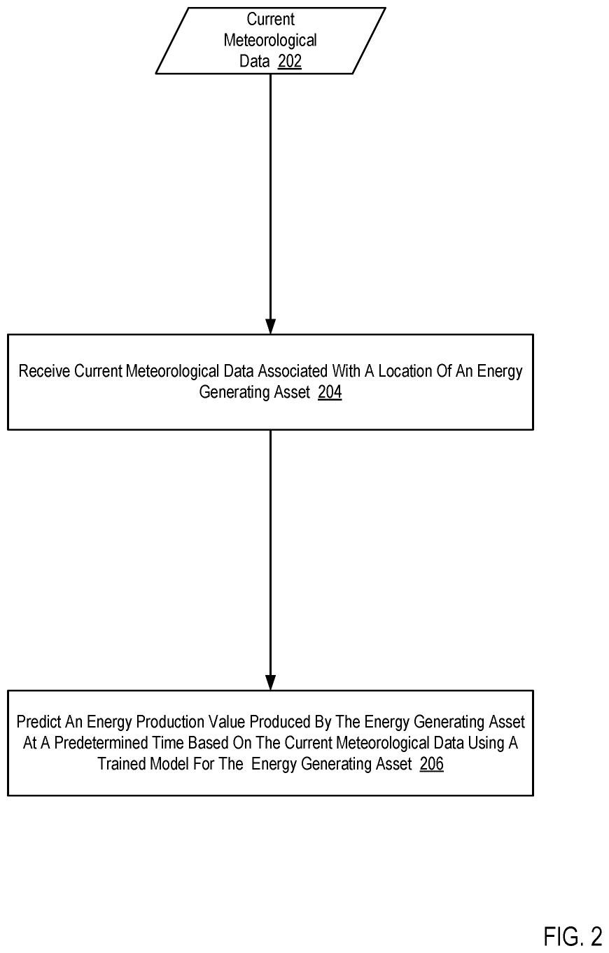

For further explanation, FIG. 2 sets forth a flowchart illustrating an example method of predicting energy production for energy generating assets in accordance with some embodiments of the present disclosure. The example method depicted in FIG. 2 may be carried out, for example, by one or more modules of computer program instructions executing on computer hardware, by one or more modules of computer program instructions executing on virtualized computer hardware, by one or more modules of computer program instructions executing in a container, or by one or more modules of computer program instructions executing in some other form of execution environment. The example method depicted in FIG. 2 may similarly be carried out by an apparatus, system, or other device that is configured to execute computer program instructions specifically designed to carry out the steps described herein.

The example method depicted in FIG. 2 includes receiving 204 current meteorological data 202 associated with a location of an energy generating asset. The energy generating asset may be embodied, for example, as a wind turbine, a solar energy array, a hydroelectric energy source, a geothermal energy source, any other renewable energy production source, or any other suitable energy production source. Although various examples are described herein using a single energy generating asset, it should be understood that in other embodiments multiple energy generating assets may be used. For example, a number of wind turbines may be located at a site to form a wind farm. The current meteorological data 202 may be embodied, for example, as a data structure, a file, or a stream of data from a meteorological data feed. The current meteorological data 202 may include information describing, for example, measured windspeed at a particular point in time, measured wind direction at a particular point in time, measured temperature at a particular point in time, measured dew point at a particular point in time, measured cloud cover at a particular point in time, or measured solar irradiation at a particular point in time. The current meteorological data 202 may include information describing a weather forecast for the location a particular time such as, for example, one hour or twenty-four hours from the present time. In an embodiment, the weather forecast may be determined by a weather prediction algorithm utilizing a weather forecast model or an ensemble of weather forecast models.

In the example method depicted in FIG. 2, the current meteorological data 202 that is associated with a location of the energy generating asset may be received 204, for example, via a weather feed from a server, or via meteorological data from sensors located proximate to or remote from the location of the energy generating asset. As an example in which the current meteorological data 202 is received from one or more sensors, the current meteorological data 202 may be received via one or more anemometers that are positioned at various locations within the wind farm described above. The anemometers may be affixed to a particular turbine or positioned in some other way so as to provide accurate wind speed readings at the height of the turbine (whereas wind speeds measured from a meteorological service or some other entity may be measured at a height that is significantly different than the height of the turbines). As such, the current meteorological data 202 that is associated with a location of the energy generating asset may be received 204 by measuring such data 202 at the location of the energy generating asset.

In other embodiments, the current meteorological data 202 that is associated with a location of the energy generating asset may be received 204 by applying trained models or algorithms that be used to extrapolate the current meteorological data 202. Continuing with the example described above in which the energy generation asset is a wind turbine in a wind farm, assume for the purposes of this example that an anemometer that is affixed to the wind turbine has failed and is no longer able to provide wind speed readings. In such an example, however, the wind speed at the wind turbine may be predicted using a trained model. The trained model may be created, for example, by providing historical readings from an anemometer that is affixed to the wind turbine and also providing historical readings from anemometers that are affixed to other wind turbines in the wind farm as training data to a machine learning algorithm. In such a way, a trained model may be generated that can be used to predict the wind speed at the wind turbine by using the values provided by anemometers that are affixed to other wind turbines in the wind farm. Readers will appreciate that in other embodiments, additional information (e.g., wind direction) may be included in the training data that is used to generate a trained model that can predict the wind speed at the turbine based on measured readings from other sensors.

The example method depicted in FIG. 2 also includes predicting 206 an energy production value produced by each energy generating asset at a predetermined time. In the example method depicted in FIG. 2, the energy production value produced by each energy generating asset at a predetermined time is predicted 206 based on the current meteorological data 202 using a trained model for the energy generating asset. The trained model may be trained using a machine learning algorithm that utilizes historical and forecasted meteorological data associated with the location of the energy generating asset and historical production capability data associated with a historical production capability of the energy generating asset. The historical meteorological data may include previous meteorological conditions at the location of the energy generating asset.

Continuing with the example described above in which the energy generation asset is a wind turbine in a wind farm, the historical meteorological data may include an indication of a windspeed previously measured during a particular time period by an anemometer at a location near the wind farm, and the historical production capability data may include a corresponding power output of the wind turbine during the same time period. Further, the historical meteorological data may include an indication of a number of different windspeed measurements collected at different times and corresponding power output measurements of the wind turbine. As a result, the trained model may be trained using a number of different meteorological windspeed measurements and corresponding power outputs of the wind turbine to construct a trained model that is capable of accurately predicting a corresponding wind turbine power output corresponding to a range of meteorological windspeeds.

In an example in which the energy generation asset is a solar power array in a solar power farm, the historical meteorological data may include an indication of a solar irradiation calculated from measurements collected during a particular time period by meteorological instrumentation (such as a solar met station or a pyranometer) at location near the solar power farm, and the historical production capability data may include an indication of a corresponding power output measurement of the solar power array or a solar inverter during the same period. Similarly, the trained model may be trained using a number of different solar irradiance measurements and corresponding power outputs of the solar power array to construct a trained model that is capable of accurately predicting a corresponding a solar array power output corresponding to a range of solar irradiance values. In some example embodiments, the trained model may be trained using other parameters that have an effect on solar irradiance as an alternative or in addition to measured solar irradiance such as seasonal data, the time of day, the amount of cloud cover, and amount/type of precipitation, or other data.

In the example method depicted in FIG. 2, the trained model may predict 206 an energy production value produced by the energy generating asset at a predetermined time by using the current meteorological data as an input to the trained model to predict an energy production value corresponding to an expected energy production value produced by the energy generated at the predetermined time. The trained model may predict 206 the energy production value through the use of one or more machine learning algorithms that can correlate historical production capability data with historical meteorological data and receive the current meteorological data as an input to the trained model to predict the energy production value. Such machine learning algorithms can include, for example regression learning algorithms, unsupervised learning algorithms, supervised learning algorithms, neural network algorithms, deep learning algorithms, learning vector quantization algorithms, decision tree algorithms, or other suitable machine learning algorithms.

In another embodiment, a site location may include a number of different energy generating assets and a different trained model for each of the energy generating asset may be created using historical meteorological data and the historical production capability data associated with the particular energy generating asset. During the particular embodiment, an energy production value for each energy production value is predicted using the current meteorological data 202 and the trained model corresponding to the particular energy generating asset. In addition, an energy production value for the site may be computed using a combination of the individual predicted energy productions values of each energy generating asset.

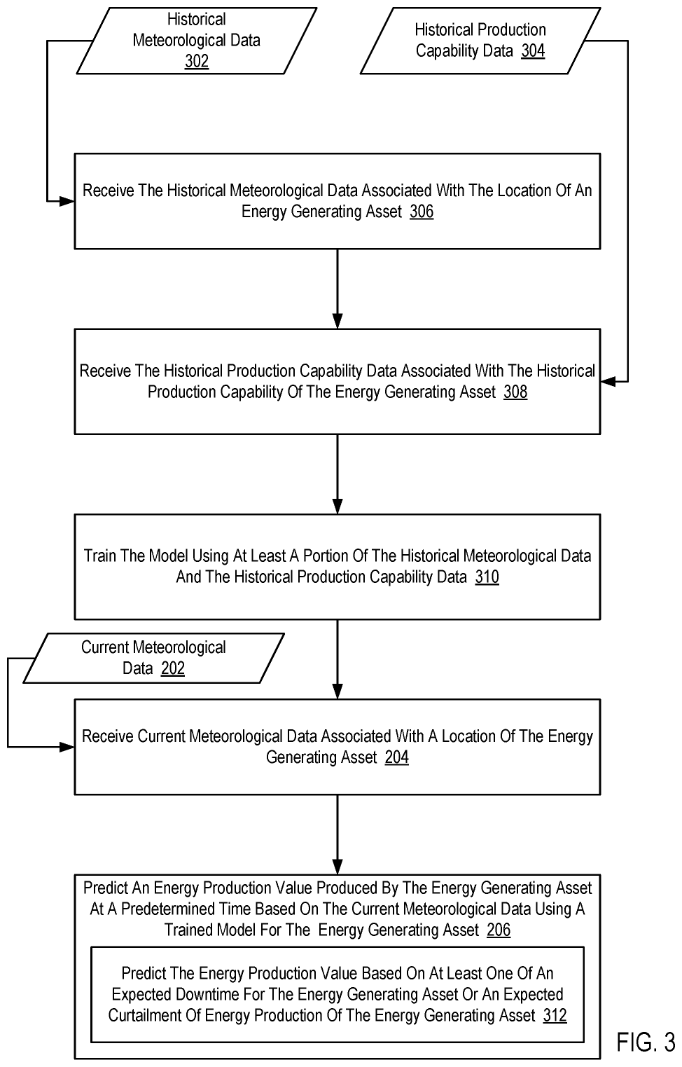

For further explanation, FIG. 3 sets forth a flowchart illustrating an additional example method of predicting energy production for energy generating assets in accordance with some embodiments of the present disclosure. The example depicted in FIG. 3 is similar to the example depicted in FIG. 2, as the example depicted in FIG. 3 also includes receiving 204 current meteorological data 202 associated with a location of an energy generating asset and predicting 206 an energy production value produced by the energy generating asset at a predetermined time. For example, it may be desired to predict the energy production for the energy generating asset at a time of twenty-four hours in the future in order to accurately forecast next-day production for the energy generating asset. In the example, the current meteorological data 202 may include a wind speed forecast for the location in twenty-four hours. Another example method includes receiving current meteorological data associated with a location of a number of energy generating assets, such as number of wind turbines at a wind farm, and predicting an energy production value for each of the energy generating assets to accurately forecast site level production for a combination of all of the energy generating assets at the location.

In still another example, current meteorological data may be received from a number of sources at different locations near the energy generating asset, and the current meteorological data 202 associated with the location of the energy generating asset may be computed using one or more of the individual current meteorological data received from each of the sources. In a particular example, the individual current meteorological data may each be weighted according to a weighting algorithm, and a weighted combination, such as an average, of the individual current meteorological data may be used to compute the current meteorological data 202 to be used as an input to the trained model to predict the energy production value produced by the energy generating asset at the predetermined time. In another particular example, one of the individual sources may be determined to be the “best” source for current meteorological data for the location of the energy generating asset, and be used as the current meteorological data 202 to be input to the trained model to predict the energy production value produced by the energy generating asset at the predetermined time.

The example method depicted in FIG. 3 also includes receiving 306 the historical meteorological data 302 associated with the location of the energy generating asset. The historical meteorological data 302 may be embodied as, for example, a data structure, a file, or a stream of data from a meteorological data feed. The historical meteorological data 302 may include, for example, historical wind speeds and/or historical wind directions associated with the location of the energy generating asset. In an example, the historical meteorological data 302 associated with the location of the energy generating asset may include historical wind speeds for the previous month at particular times during the month. In another example, the historical meteorological data 302 may include historical wind speeds for the previous year at particular times during the year.

In the example method depicted in FIG. 3, the historical meteorological data 302 may be received 306, for example, by querying a database or repository storing historical meteorological data associated with the location and receiving a response to the query including the request historical meteorological data. In an embodiment, the repository is created and historical meteorological data 302 is obtained from one or more meteorological data sources, such as a weather service, and stored in the repository. In various embodiments, the repository may be located either at a remote location from the energy generating asset or proximate to the energy generating asset. In one or more embodiments, the historical meteorological data 302 may be stored using a cloud storage service.

The example method depicted in FIG. 3 also includes receiving 308 the historical production capability data 304 associated with the historical production capability of the energy generating asset. The historical production capability data 304 may be embodied as, for example, a data structure, a file, or a stream of data from a data feed. The historical production capability data may include at least one of a historical availability of the energy generating asset or a historical energy production of the energy generating asset. The historical production capability data 304 may include information describing a previous energy production capability of the energy generating asset during different conditions and/or times in the past. For example, an energy generating asset in the form of a wind turbine may produce a greater amount of energy during conditions of relatively high wind speeds than the energy produced during conditions of relatively low wind speeds. In another example, an energy generating asset in the form of solar inverters may produce a greater amount of energy during conditions of a relatively low amount of cloud cover than the energy produced during conditions of a relatively high amount of cloud cover.

In the example method depicted in FIG. 3, the historical production capability data 304 may be received 308, for example, by querying a database or repository storing historical production capability associated with the energy generating asset and receiving a response to the query including the request historical production capability data. In an embodiment, the repository is created and historical production capability data 304 is obtained from previously measured production capability of the energy generating asset and stored in the repository. In various embodiments, the repository may be located either at a remote location from the energy generating asset or proximate to the energy generating asset. In one or more embodiments, the historical production capability data 304 may be stored using a cloud storage service.

The example method depicted in FIG. 3 also includes training 310 the model using at least a portion of the historical meteorological data 302 and the historical production capability data 304. Training 310 the model may be carried out, for example, through the use of one or more machine learning algorithms that can correlate historical production capability data 304 with historical meteorological data 302. Such machine learning algorithms can include, for example regression learning algorithms, unsupervised learning algorithms, supervised learning algorithms, neural network algorithms, deep learning algorithms, learning vector quantization algorithms, decision tree algorithms, or other suitable machine learning algorithms. During the training 310, the trained model may be trained using a machine learning algorithm that utilizes the historical meteorological data 302 associated with the location of the energy generating asset and historical production capability data 304 associated with a historical production capability of the energy generating asset. The model may be trained using historical meteorological data 302 that covers a range of various meteorological conditions expected to be experienced by the energy generating asset and a range of production capabilities corresponding to the various meteorological conditions to produce an accurate trained model of the energy generating asset.

Through the use of the machine learning algorithms and techniques, a model may be generated that can receive current meteorological data associated with a location of an energy generating asset and predict an amount of energy that would be generated by the energy generating asset a predetermined time in the future.

The example method depicted in FIG. 3 also includes predicting 206 an energy production value produced by each energy generating asset at a predetermined time based on the current meteorological data 202 using the trained model for the energy generating asset. In another embodiment, a site location may include a number of different energy generating assets and a different trained model for each of the energy generating asset may be created using at least a portion of the historical meteorological data 302 and the historical production capability data 304 associated with the particular energy generating asset. During the particular embodiment, an energy production value for each energy production value is predicted using the current meteorological data 202 and the trained model corresponding to the particular energy generating asset. In addition, an energy production value for the site may be computed using a combination of the individual predicted energy productions values of each energy generating asset.

In the example method depicted in FIG. 3, predicting 206 an energy production value produced by the energy generating asset at a predetermined time may be further based on at least one of an expected downtime for the energy generating asset or an expected curtailment of energy production of the energy generating asset 312. For example, if a particular section of a wind farm or other energy generating asset is expected to be out of operation because of a substation repair, actual energy production by the energy generating asset may be significantly affected. In another example, a planned grid curtailment of the energy generating asset may also have a significant impact on actual energy production. In such situations, the predicted energy production value produced by the energy generating asset may be modified to account for the effects of the expected downtime and/or curtailment of the energy generating asset.

In another example predicting 206 an energy production value produced by the energy generating asset at a predetermined time may be further based on a health score associated with the energy generating asset. The health score associated with the energy generating asset may be indicative of an operational condition or “health” of the energy generating asset. In the example, the operational condition of the energy generating asset may have an effect on the amount of energy that the energy generating asset is capable of producing under certain conditions. In the example, if the health score of the energy generating asset is determined to have an effect on the amount of energy that the energy generating asset is capable of producing under the operational conditions at the predetermined time, the predicted energy production value may be modified to account for the health score.

In an embodiment, a maintenance event for the energy generating asset may be determined based on the predicted energy production value. For example, the maintenance event may be determined based on the predicted energy production value being less than a predetermined threshold value representative of the predicted energy production value being relatively low during the predetermine time. A maintenance event may include, for example, performing an equipment repair, an equipment replacement, a maintenance operation, or an equipment upgrade on the energy generating asset. In response to the determined maintenance event, an operator of the energy generating asset may choose to perform maintenance on the energy generating asset at a time during which production loss due to the energy generating asset being unavailable is minimized.

In another embodiment, at least a portion of a current energy production produced by the energy generating asset may be provided to at least one of a cryptocurrency mining operation or at least one energy storage device based on the predicted energy production value. In an embodiment, providing a portion of the current energy production to the cryptocurrency mining operation or at least one energy storage device is further based on a pricing forecast for produced energy. A cryptocurrency mining operation may include one or more computing devices configured to perform cryptocurrency computing operations such as mining a particular cryptocurrency. The computing devices often require high power demands when performing these cryptocurrency computing operations. An energy storage device may include one or more batteries, capacitors, or other storage devices configured to store power generated by the energy generating asset to be provided later to a consumer. During a time at which demand for power is expected to be low, an operator may determine to allocate generated energy production from the energy generating asset to charge energy storage devices rather than providing the generated energy production the electrical grid. If the energy storage devices are sufficiently charged during a time of low power demand, the operator may determine to allocate the generated energy production from the energy generating asset to a cryptocurrency mining operation instead of allowing the generated energy production to be wasted. Accordingly, allocation of generated energy production can be optimized.

Due to variable fuel (e.g., wind or solar irradiance) load owners and operators of renewable energy power plants often face challenges in optimizing revenue. For example, at times of high wind speeds or during daylight hours with high irradiances, grid operators may sometimes request curtailment of energy generating sites due to high grid load which results in reduced operational efficiency of the energy generating asset or the renewable energy power plants as a whole. Curtailment and inefficient downtime planning may result in potential revenue loss for renewable energy power plants. By evaluating predicted energy production against pricing forecasts, recommendations may be provided to operators to select from options such as energy storage, cryptocurrency mining, maintenance, or curtailment to maximize site revenue potential.

In an embodiment, periodic (e.g., hourly or daily) forecasts for pricing may be determined based on historical pricing data. Further, periodic (e.g., hourly or daily) wind speed forecasts are determined at each of the energy generating assets (e.g., a turbine hub height). As a result, hourly or daily production forecasts for the renewable energy power plant may be computed using the wind speed information excluding any energy generating assets with active downtime. In a particular example, determining whether a particular energy generating asset is going to experience an active downtime may be based upon live data being received from the renewable energy generating power plant. The energy production forecast data may then be used to determine the best short term revenue optimization opportunity.

In an example, if the pricing forecast in the near future (e.g., a few hours out) is high when winds are low, allocated generated energy to storage may be assigned as the optimal strategy for revenue optimization. If the pricing forecast for the near future is low during high winds in the future, as much generated energy as possible may be allocated to the grid for the short term, and then allocated to storage in the future when high winds are expected. If storage is determined to be full, the generated energy may be allocated to cryptocurrency mining.

An embodiment of a non-transitory computer-readable medium may store instructions, that when executed by at least one processor, cause at least one processor to receive current meteorological data associated with a location of an energy generating asset, and predict an energy production value produced by the energy generating asset at a predetermined time based on the current meteorological data using a trained model for the energy generating asset. The trained model may be trained using a machine learning algorithm that utilizes historical meteorological data associated with the location of the energy generating asset and historical production capability data associated with a historical production capability of the energy generating asset.

In an embodiment, the instructions may further cause at least one processor to receive the historical meteorological data associated with the location of the energy generating asset, receive the historical production capability data associated with the historical production capability of the energy generating asset, and train the model using at least a portion of the historical meteorological data and the historical production capability data.

In an embodiment, the energy production value may be further updated based on at least one of an expected downtime for the energy generating asset or an expected curtailment of energy production of the energy generating asset.

In an embodiment, the instructions further cause at least one processor to determine a maintenance event window for the energy generating asset based on the predicted energy production value. In an embodiment, the instructions further cause the at least one processor to provide, based on the predicted energy production value, at least a portion of a current energy production produced by the energy generating asset to at least one of a cryptocurrency mining operation or at least one energy storage device.

An embodiment of an apparatus includes at least one processor, and at least one memory. The at least one memory storing instructions, that when executed by the at least one processor, cause the at least one processor to receive current meteorological data associated with a location of an energy generating asset, and predict an energy production value produced by the energy generating asset at a predetermined time based on the current meteorological data using a trained model for the energy generating asset. The trained model may be trained using a machine learning algorithm that utilizes historical meteorological data associated with the location of the energy generating asset and historical production capability data associated with a historical production capability of the energy generating asset.

In an embodiment, the instructions further cause the at least one processor to receive the historical meteorological data associated with the location of the energy generating asset, receive the historical production capability data associated with the historical production capability of the energy generating asset, and train the model using at least a portion of the historical meteorological data and the historical production capability data.

In an embodiment, predicting the energy production value is further based on at least one of an expected downtime for the energy generating asset or an expected curtailment of energy production of the energy generating asset. In an embodiment, the instructions further cause the at least one processor to determine a maintenance event for the energy generating asset based on the predicted energy production value.

In view of the explanations set forth above, readers will recognize that the benefits of predicting energy production for energy generating assets include:
Increased accuracy for forecasting energy production by an energy generating asset to provide for more optimized allocation of generated energy resources such as deciding to provide power to an electric grid, storage devices, or cryptocurrency mining operations at a particular time.
Allows scheduling of maintenance operations of energy generating assets at times of low expected production.

Example embodiments of the present disclosure are described largely in the context of a method for predicting energy production for energy generating assets in accordance with some embodiments of the present disclosure. Readers will appreciate, however, that the present disclosure also can be embodied in a computer program product disposed upon computer readable storage media for use with any suitable data processing system. Such computer readable storage media can be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the disclosure as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present disclosure.

The present disclosure can be a system, a method, and/or a computer program product. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++or the like, and conventional procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams can represent a module, segment, or portion of instructions, which includes one or more executable instructions for implementing the specified logical function(s). In some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes can be made in various embodiments of the present disclosure. The descriptions in this specification are for purposes of illustration only and are not to be construed in a limiting sense. The scope of the present disclosure is limited only by the language of the following claims.

What is claimed is:

1. A method, comprising:
receiving current meteorological data associated with a location of an energy generating asset; and
predicting an energy production value produced by the energy generating asset at a predetermined time based on the current meteorological data using a trained model for the energy generating asset, the trained model being trained using a machine learning algorithm that utilizes historical and forecasted meteorological data associated with the location of the energy generating asset and historical production capability data associated with a historical production capability of the energy generating asset.

2. The method of claim 1, further comprising:
receiving the historical meteorological data associated with the location of the energy generating asset;
receiving the historical production capability data associated with the historical production capability of the energy generating asset; and
training the model using at least a portion of the historical meteorological data and the historical production capability data.

3. The method of claim 1, wherein predicting the energy production value is further based on at least one of an expected downtime for the energy generating asset or an expected curtailment of energy production of the energy generating asset.

4. The method of claim 1, further comprising:
determining a maintenance event window for the energy generating asset based on the predicted energy production value.

5. The method of claim 4, wherein the maintenance event window is determined based on the predicted energy production value being less than a predetermined threshold value.

6. The method of claim 1, further comprising:
providing, based on the predicted energy production value, at least a portion of a current energy production produced by the energy generating asset to at least one of a cryptocurrency mining operation or at least one energy storage device.

7. The method of claim 6, wherein providing of the at least a portion of the current energy production to the cryptocurrency mining operation or at least one energy storage device is further based on a pricing forecast for produced energy.

8. The method of claim 1, wherein the current meteorological data comprises a weather forecast for the location at the predetermined time.

9. The method of claim 1, wherein the historical production capability data comprises at least one of a historical availability of the energy generating asset or a historical energy production of the energy generating asset.

10. The method of claim 1, wherein the energy generating asset comprises at least one of a wind turbine or a solar energy array.

11. The method of claim 1, wherein the historical meteorological data includes historical wind speeds associated with the location.

12. A non-transitory computer-readable medium storing instructions, that when executed by at least one processor, cause the at least one processor to:
receive current meteorological data associated with a location of an energy generating asset; and
predict an energy production value produced by the energy generating asset at a predetermined time based on the current meteorological data using a trained model for the energy generating asset, the trained model being trained using a machine learning algorithm that utilizes historical and forecasted meteorological data associated with the location of the energy generating asset and historical production capability data associated with a historical production capability of the energy generating asset.

13. The non-transitory computer-readable medium of claim 12, wherein the instructions further cause the at least one processor to:
receive the historical meteorological data associated with the location of the energy generating asset;
receive the historical production capability data associated with the historical production capability of the energy generating asset; and
train the model using at least a portion of the historical meteorological data and the historical production capability data.

14. The non-transitory computer-readable medium of claim 12, wherein predicting the energy production value is further based on at least one of an expected downtime for the energy generating asset or an expected curtailment of energy production of the energy generating asset.

15. The non-transitory computer-readable medium of claim 12, wherein the instructions further cause the at least one processor to determine a maintenance event window for the energy generating asset based on the predicted energy production value.

16. The non-transitory computer-readable medium of claim 12, wherein the instructions further cause the at least one processor to provide, based on the predicted energy production value, at least a portion of a current energy production produced by the energy generating asset to at least one of a cryptocurrency mining operation or at least one energy storage device.

17. An apparatus, comprising:
at least one processor; and
at least one memory, the at least one memory storing instructions, that when executed by the at least one processor, cause the at least one processor to:
receive current meteorological data associated with a location of an energy generating asset; and
predict an energy production value produced by the energy generating asset at a predetermined time based on the current meteorological data using a trained model for the energy generating asset, the trained model being trained using a machine learning algorithm that utilizes historical and forecasted meteorological data associated with the location of the energy generating asset and historical production capability data associated with a historical production capability of the energy generating asset.

18. The apparatus of claim 17, wherein the instructions further cause the at least one processor to:
receive the historical meteorological data associated with the location of the energy generating asset;
receive the historical production capability data associated with the historical production capability of the energy generating asset; and
train the model using at least a portion of the historical meteorological data and the historical production capability data.

19. The apparatus of claim 17, wherein predicting the energy production value is further based on at least one of an expected downtime for the energy generating asset or an expected curtailment of energy production of the energy generating asset.

20. The apparatus of claim 17, wherein the instructions further cause the at least one processor to determine a maintenance event window for the energy generating asset based on the predicted energy production value.
